(19) United States
(12) Patent Application Publication
(10) Pub. No.: US 2026/0202203 A1
(43) Pub. Date: Jul. 16, 2026

(54) TRAJECTORY PROCESSING METHOD, DEVICE, AND COMPUTER-READABLE STORAGE MEDIUM

(71) Applicant: JIANGSU DONGCHENG TOOLS TECHNOLOGY CO., LTD., NANTONG (CN)

(72) Inventors: Chong WU, NANTONG (CN); Yunbo HONG, NANTONG (CN); Wenjing QI, NANTONG (CN)

(73) Assignee: JIANGSU DONGCHENG TOOLS TECHNOLOGY CO., LTD., NANTONG (CN)

(21) Appl. No.: 18/862,560

(22) PCT Filed: May 18, 2024
(86) PCT No.: PCT/CN2024/094090

§ 371 Date: Nov. 4, 2024

(30) Foreign Application Priority Data
Aug. 25, 2023 (CN) 202311088329.3

(51) Int. Cl. G01C 21/20

(52) U.S. Cl. CPC G01C 21/20

(57) ABSTRACT

A trajectory processing method, a device, and a computer-readable storage medium, and relates to the field of computers. The method includes obtaining target deviation data configured to indicate deviation between a first trajectory point and a second trajectory point; calculating target deviation-correction data of a current iteration based on the target deviation data; and iteratively correcting at least one of N trajectory points in a first boundary based on the target deviation-correction data, enabling target deviation data to meet a preset threshold, wherein the first boundary is a boundary composed of the second trajectory point in an initial trajectory and a plurality of trajectory points within a preset range of the second trajectory point.

### CROSS REFERENCE TO RELATED APPLICATIONS

The present disclosure is a 35 U.S.C. § 371 National Phase conversion of International (PCT) Patent Application No. PCT/CN2024/094090, filed on May 18, 2024, which claims priority to Chinese Patent Application No. 202311088329.3, filed on Aug. 25, 2023, the entire disclosures of which are incorporated herein by reference.

### TECHNICAL FIELD

The present disclosure relates to the field of computer technologies, and in particular to a trajectory processing method, a device, and a computer-readable storage medium.

### BACKGROUND

With the rapid development of the new energy field, the application of device self-control automation is becoming increasingly widespread.

The device will drive according to a preset route to complete an instruction. However, in related art, due to an influence of device walking deviation and sensor errors, deviations may be generated during a generation process of the preset route (i.e., trajectory), resulting in a trajectory route that may not form a closed-loop, leading to technical problems such as failure or inaccuracy in mapping a working area.

### SUMMARY OF THE DISCLOSURE

In the first aspect, the present disclosure provides a trajectory processing method, applied to a processor and including: obtaining target deviation data configured to indicate deviation between a first trajectory point and a second trajectory point; calculating target deviation-correction data of a current iteration based on the target deviation data; and iteratively correcting at least one of N trajectory points in a first boundary based on the target deviation-correction data, enabling target deviation data to meet a preset threshold. The first boundary is a boundary composed of the second trajectory point in an initial trajectory and a plurality of trajectory points within a preset range of the second trajectory point.

In the second aspect, the present disclosure provides a device including a storage and a processor. The storage is configured to store a computer program. The computer program is executed by the processor to implement a trajectory processing method according to the first aspect.

In the third aspect, the present disclosure provides a computer-readable storage medium, configured to store a computer program. The computer program is performed by a processor to implement a trajectory processing method according to the first aspect.

### BRIEF DESCRIPTION OF THE DRAWINGS

The embodiments of the present disclosure are further described in detail below in conjunction with the accompanying drawings.

FIG. 1 is a schematic application scenario view of a trajectory processing method according to some embodiments of the present disclosure.

FIG. 2 is a flow chart of a trajectory processing method according to some embodiments of the present disclosure.

FIG. 3a is a schematic trajectory view of a trajectory processing method according to some embodiments of the present disclosure.

FIG. 3b is a schematic trajectory view of a trajectory processing method according to some embodiments of the present disclosure.

FIG. 4a is a schematic trajectory view of a trajectory processing method according to some embodiments of the present disclosure.

FIG. 4b is a schematic trajectory view of a trajectory processing method according to some embodiments of the present disclosure.

FIG. 5 is a schematic trajectory view of a trajectory processing method according to some embodiments of the present disclosure.

FIG. 6 is a schematic structural view of a trajectory processing apparatus according to some embodiments of the present disclosure.

FIG. 7 is a schematic structural view of a computer device according to some embodiments of the present disclosure.

### DETAILED DESCRIPTION

The inventor discovered that in related art, in the process of constructing a map based on a trajectory, non-coincidence of trajectory points or errors may lead to problems such as a starting point and an ending point may not coincide and a path may not form a closed-loop.

In order to solve the problems, embodiments of the present disclosure provide a trajectory processing method.

In related art, an intelligent device starts from a preset starting point based on a boundary line to complete a designated route, and returns to the preset starting point. During driving along the route, the intelligent device may establish a map describing a trajectory based on the actual driving environment, that is, a trajectory route simulated by the intelligent device. However, limited by the accuracy of sensors and the cumulative error of the odometer, the map established by the intelligent device returning to a starting position along the boundary line is not a closed-loop environmental map.

In view of the deviation problem caused by the process of generating the map from a driving trajectory of the intelligent device, the embodiments of the present disclosure provide the trajectory processing method. By obtaining multiple trajectory points, performing deviation correction processing in response to target deviation data between the multiple trajectory points not meeting a preset requirement, obtaining deviation correction data, and performing the deviation correction processing on the trajectory points based on the deviation correction data, technical effect of precisely correcting a trajectory map may be achieved, improving the efficiency and accuracy of trajectory generation.

The embodiments of the present disclosure corrects a trajectory driven by the intelligent device to an initial position by using a proportional correction method, and improves the map established by the intelligent device after driving along the route through methods such as scattered point completion and angle threshold correction to form a closed-loop in the form of an obtuse angle. In this way, the problem of low working efficiency caused by non-closed maps or unsmooth maps with large fluctuations and changes is effectively solved, improving the working efficiency of a lawn mower to cut along a line.

The solutions in the embodiments of the present disclosure may be implemented in various computer languages, such as object-oriented programming languages (e.g., Java) and interpreted scripting languages (e.g., JavaScript).

In order to make the technical solutions and advantages in the embodiments of the present disclosure clearer, the embodiments of the present disclosure are further described in detail below in conjunction with the accompanying drawings. Obviously, the described embodiments are only some embodiments of the present disclosure, not an exhaustive list of all embodiments. It should be noted that, as long as there is no conflict, the embodiments and features in the embodiments of the present disclosure may be combined with each other.

The following is a brief description of an application environment of the trajectory processing method provided by the embodiments of the present disclosure.

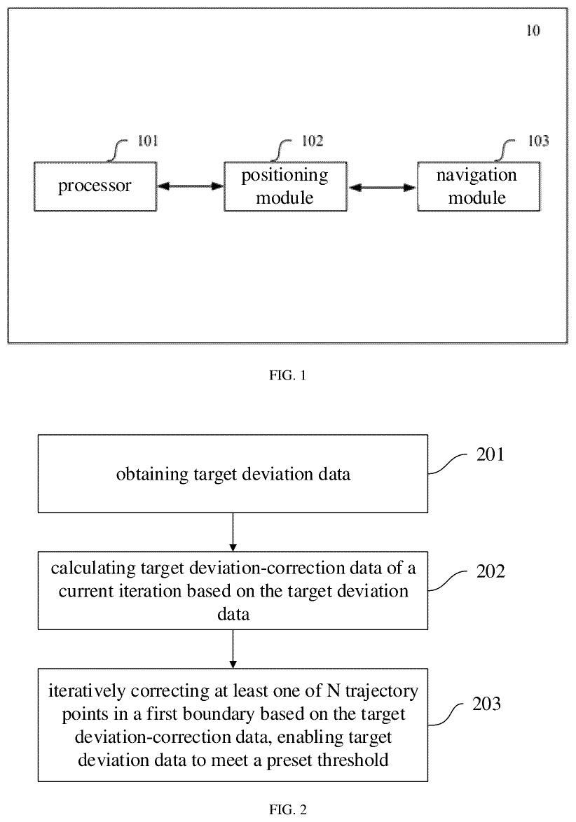

As shown in FIG. 1, the embodiments of the present disclosure provides the trajectory processing method applied to a trajectory processing system 10. The trajectory processing system 10 includes a processor 101, a positioning module 102, and a navigation module 103. After the processor 101 establishes a connection with the positioning module 102, the processor 101 obtains real-time position information sent by the positioning module 102, generates trajectory information based on the real-time position information, and performs deviation correction processing on the trajectory information according to a preset algorithm to generate a closed-loop navigation map. The navigation module 103 guides a machine to operate according to the navigation map.

The processor 101 performing the deviation correction processing at least includes performing denoising operations such as filtering processing, cross-surrounding error correction, and correction of trajectory points with trajectory offsets exceeding a preset threshold on trajectory data in sequence, performing smoothing processing on denoised trajectory data, and performing thinning and interruption compensation on smoothed trajectory data in in sequence.

The trajectory processing system may be deployed in an intelligent device, or in a server or terminal device. The intelligent device may complete automatic driving of a fixed route according to the navigation module. The server or terminal device may obtain the navigation information corrected by the processor through the navigation module and command intelligent tools to complete automatic driving. The intelligent device may at least include an intelligent garden tool or intelligent robot.

As shown in FIG. 2, in the following embodiments, taking the processor 101 of the trajectory processing system 10 as the execution subject, the method provided in the embodiments of the present disclosure is applied to a scene where a trajectory cannot be closed for detailed description. The trajectory processing method provided by the embodiments of the present disclosure may include operations executed by block 201 to block 203.

At block 201, target deviation data is obtained.

The target deviation data is configured to indicate deviation between a first trajectory point and a second trajectory point.

The target deviation data between the first trajectory point and the second trajectory point may be coordinate deviation of the first trajectory point and the second trajectory point in a target coordinate system, deviation in distance between the first trajectory point and the second trajectory point, or deviation in an intersection angle between the first trajectory point and the second trajectory point. The target deviation data may be determined in combination with actual deviation in the map generated by the driving trajectory of the device.

At block 202, target deviation-correction data of a current iteration is calculated based on the target deviation data.

The target deviation-correction data is configured to indicate data that may correct the deviation between the first trajectory point and the second trajectory point. The target deviation-correction data may include coordinate data, numerical data, angle data, etc., and may be determined according to different correction algorithms.

In the embodiments of the present disclosure, after obtaining the target deviation-correction data, a pre-judgment may be performed. In response to the target deviation-correction data being greater than a preset threshold, correction processing may be performed. In some embodiments, a prompt message may be generated. The user may determine a next operation according to the prompt message, such as performing map optimization, trajectory correction, or actual surveying and analyzing the cause of trajectory point offset.

At block 203, at least one of N trajectory points in a first boundary is iteratively corrected based on the target deviation-correction data, enabling target deviation data to meet the preset threshold.

The first boundary refers to a boundary composed of the second trajectory point in an initial trajectory and a plurality of trajectory points within a preset range of the second trajectory point.

A preset trajectory is a trajectory generated according to a path preset and planned by the intelligent device. The intelligent device may complete walking from a starting point to an ending point according to the preset trajectory and capture trajectory points of the intelligent device in real time to generate the initial trajectory.

In the embodiments of the present disclosure, iteratively correcting the N trajectory points in the first boundary includes calculating displacement data of each of the N trajectory points in the first boundary corrected by the current iteration based on the target deviation-correction data of the current iteration; calculating deviation values of the first trajectory point and the second trajectory point based on the displacement data, and updating the target deviation data; in response to the target deviation data being greater than or equal to the preset threshold, calculating target deviation-correction data of a current iteration based on the target deviation data, and iteratively correcting the N trajectory points in the first boundary based on the target deviation-correction data; and in response to the target deviation data being less than the preset threshold, stopping an iterative correction process.

In the embodiments of the present disclosure, the correction process of the trajectory data is completed by obtaining correction data between the first trajectory point and the second trajectory point, and processing the second trajectory point and the data adjacent to the second trajectory point based on the correction data.

In some embodiments of the present disclosure, the obtaining target deviation data at block 201 may executed by block 301 to block 302.

At block 301, position information of the starting point in the preset trajectory and position information of the ending point of the first boundary are obtained.

The first boundary refers to a boundary composed of the ending point in the initial trajectory and a plurality of trajectory points within a preset range of the ending point. The starting point is the first trajectory point and the ending point is the second trajectory point.

The number of selected trajectory points in the preset range may be determined by device parameters of the intelligent device. For example, select R trajectory points near the ending point, and a value range of R is determined by a walking positioning error of the intelligent device. Taking the positioning error δ=1 m of a robot in a scene with an area of 500 m² and the frequency F=30 times/m of the robot recording trajectory points as an example, R=40. Generally, the value range of R is F≤R≤2F.

R trajectory points is selected near the ending point, and the value of R depends on the positioning error of the robot.

The positioning error is determined based on the overall length of the actual trajectory. A range of trajectory points to be corrected is determined by taking a simulated ending point in the actual walking trajectory of the robot as a center and R trajectory points as a radius.

At block 302, target deviation data between the ending point and the starting point is obtained based on the position information of the starting point and the position information of the ending point of the first boundary.

As described at block 201, the target deviation data may include various types of data. Two types of data, angle and distance, are enumerated for exemplary illustration.

When the target deviation data is configured to indicate distance deviation between the second trajectory point and the first trajectory point, the target deviation data may be calculated by various distance calculation algorithms such as Euclidean distance, Manhattan distance, Chebyshev distance, and etc.

The distance deviation calculated by Euclidean distance is taken as an example, a first distance between the second trajectory point and the first trajectory point in a direction of X-axis may be calculated according to formula: Lx=x_{end}−xₛₜₐᵣₜ, and a second distance between the second trajectory point and the first trajectory point in a direction of Y-axis may be calculated according to formula: Ly=y_{end}−yₛₜₐᵣₜ. Lx represents the first distance, x_{end} represents the coordinate value of the second trajectory point in the X-axis, and xₛₜₐᵣₜ represents the coordinate value of the first trajectory point in the X-axis. Ly represents the second distance, y_{end} represents the coordinate value of the second trajectory point in the Y-axis, and yₛₜₐᵣₜ represents the coordinate value of the first trajectory point in the Y-axis. That is, xₛₜₐᵣₜ indicates the coordinate of the starting point in the X-axis, x_{end} indicates the coordinate of the ending point in the X-axis, yₛₜₐᵣₜ indicates the coordinate of the starting point in the Y-axis, and y_{end} indicates the coordinate of the ending point in the Y-axis.

In the embodiments of the present disclosure, a deviation degree between a current trajectory and the preset trajectory may be obtained by calculating the distance deviation between the second trajectory point and the first trajectory point, thereby completing trajectory correction more accurately.

When the target deviation data is configured to indicate angle deviation between the second trajectory point and the first trajectory point, the target deviation data may be calculated based on the intersection angle between the second trajectory point and the first trajectory point.

By analyzing the target deviation data between the second trajectory point and the first trajectory point, it is convenient to determine whether the ending point coincides with the starting point of the trajectory. By performing the correction processing on the plurality of trajectory points in the first boundary, the smoothness of the trajectory is improved.

In some embodiments of the present disclosure, the calculating target deviation-correction data of the current iteration at block 202 may executed by block 401 to block 402.

At block 401, deviation values of the first trajectory point and the second trajectory point in at least one coordinate axis are obtained in sequence based on a target coordinate system.

In some embodiments of the present disclosure, target deviation values of the first trajectory point and the second trajectory point may be obtained based on the target coordinate system. The target coordinate system at least includes X-axis coordinate and Y-axis coordinate. Each of the target deviation values may be analyzed to obtain a first deviation value of the target deviation value in the X-axis coordinate and a second deviation value of the target deviation value in the Y-axis coordinate.

At block 402, target deviation-correction data of a trajectory point of the current iteration in at least one coordinate axis is calculated based on target deviation data of the first trajectory point and the second trajectory point in each coordinate axis.

A first correction value of target deviation-correction data of the current iteration in the X-axis coordinate and a second correction value of the target correction data in the Y-axis coordinate are calculated based on the first deviation value of the target deviation value in the X-axis coordinate and the second deviation value of the target deviation value in the Y-axis coordinate in the target coordinate system.

A correction value may be represented by a distance weighted. In some embodiments of the present disclosure, the distance deviation may include a distance from the X-axis and a distance from the Y-axis in the target coordinate system. Calculating the distance weighted of each trajectory point may include: obtaining the distance deviation between the second trajectory point and the first trajectory point, the distance deviation includes a distance deviation value in an X direction and a distance deviation value in a Y direction; calculating a first distance weight in the X direction and a second distance weight in the Y direction of each of the N trajectory points in the first boundary in sequence based on the distance deviation.

In some embodiments, the first distance weight in the X direction may be calculated by a

$$Wx = \frac{( R - i )}{R} \times L x .$$

formula: Where Wx represents the first distance weight, Lx represents the distance deviation value between the first trajectory point and the second trajectory point in the X direction, i represents a sequence number of the trajectory point, and R represents a total number of the trajectory points in the first boundary.

The second distance weight in the Y direction may be calculated by a formula:

$$Wy = \frac{( R - i )}{R} \times L y .$$

Where Wy represents the second distance weight, Ly represents the distance deviation value between the first trajectory point and the second trajectory point in the Y direction, i represents the sequence number of the trajectory point, and R represents the total number of the trajectory points in the first boundary.

By calculating the distance weight of each trajectory point, it is possible to quantify how much each trajectory point deviates. A correction strategy for each trajectory point may be accurately determined based on the position and the distance deviation of each trajectory point, thereby improving the accuracy of correction.

The position information of the N trajectory points in the first boundary is corrected so that the position of the first trajectory point and the position of the second trajectory point may coincide based on the distance weight of each of the N trajectory points.

In the embodiments of the present disclosure, when it is determined that the distance deviation between the second trajectory point and the first trajectory point of the trajectory is greater than a preset distance, the deviation processing may be automatically performed, or trajectory information of a current offset may be recorded and the deviation processing may be performed. By recording trajectory information of the offset, it is convenient for iterative optimization of trajectory data and improves the accuracy of trajectory generation.

In some embodiments of the present disclosure, the iteratively correcting the N trajectory points in the first boundary at block 203 may executed by block 501 to block 502.

At block 501, target deviation-correction data of the trajectory point of the current iteration in at least one coordinate axis is obtained.

At block 502, a coordinate value of the trajectory point of the current iteration in at least one axis of the target coordinate system is corrected in sequence based on the target deviation-correction data of the trajectory point in at least one coordinate axis of the target coordinate system.

The distance weight of each trajectory point may quantify a distance that each trajectory point needs to move. After moving the N trajectory points in the first boundary, the correction of the first boundary is completed.

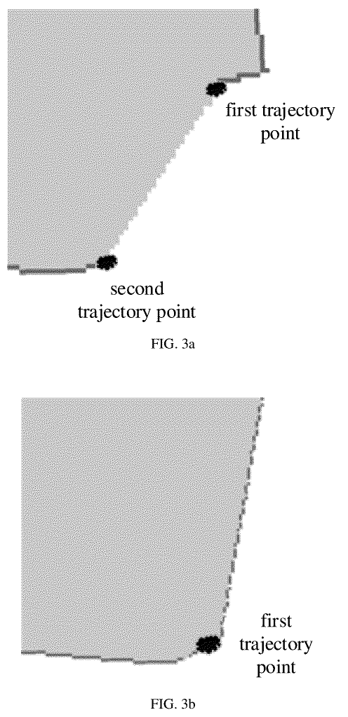

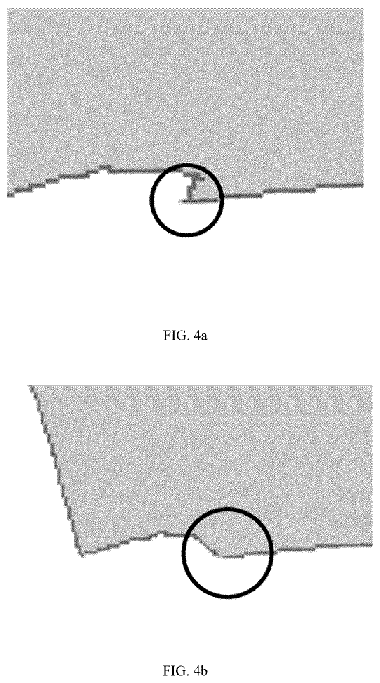

When the intelligent device walks according to the preset trajectory, the starting point and the ending point of a trajectory line as shown in FIG. 3a, may not coincide due to the device deviation or positioning deviation. Therefore, the driving trajectory needs to be corrected, making the driving trajectory to return to the first trajectory point.

In the embodiments of the present disclosure, the correcting a coordinate value of the trajectory point of the current iteration in at least one axis of the target coordinate system may include: obtaining position information (X, Y) and target distance weight of a M^{th} trajectory point among the N trajectory points in sequence based on the target coordinate system; correcting the distance of the M^{th} trajectory point in the X direction based on the first distance weight and correcting the distance of the M^{th} trajectory point in the Y direction based on the second distance weight; until completing the correction of all the trajectory points among the N trajectory points, the correction of the first boundary is completed.

In the embodiments of the present disclosure, by calculating the distance weight of each trajectory point, it is possible to quantify how much each trajectory point deviates. A correction strategy for each trajectory point may be accurately determined based on the position and the distance deviation of each trajectory point, thereby improving the accuracy of correction.

In some embodiments of the present disclosure, the calculating the target deviation-correction data of the current iteration at block 202 may executed by block 601 to block 602.

At block 601, coordinate information of the first trajectory point and coordinate information of the second trajectory point are obtained respectively based on the target coordinate system.

The first trajectory point may be a trajectory adjacent to the second trajectory.

In the embodiments of the present disclosure, during the process of capturing actual walking path points of the intelligent device, part of the trajectory points may not be collected due to unstable signals or other reasons, resulting in a large distance displacement between two adjacent trajectory points in the driving trajectory. Alternatively, after performing the correction processing on the trajectory points as described at block 203, due to the correction, the distance displacement between the two adjacent trajectory points may be large. The large distance displacement between the two adjacent trajectory points may affect the construction of the map, such as lack of points or unevenness, and may even affect the accuracy and controllability of the subsequent walking of the device. Therefore, further follow-up correction is needed.

At block 602, coordinate data of an interpolation point of the first trajectory point and the second trajectory point in the target coordinate system is determined based on the coordinate information of the first trajectory point and the coordinate information of the second trajectory point, and the target deviation-correction data is generated.

In embodiments of the present disclosure, the target deviation-correction data is generated by performing averaging processing on the coordinates of the first trajectory point and the second trajectory point.

Position information of the M^{th} trajectory point and the coordinate of an M+1^{th} trajectory point are obtained and interpolation processing is performed. The coordinate of the M^{th} trajectory point and the coordinate of an M+1^{th} trajectory point are obtained, the average processing is performed according to a formula to generate the coordinate of a P^{th} trajectory point in a simulated trajectory, i.e., an average of the position information of the M^{th} trajectory point and the coordinate of the M+1^{th} trajectory point, and the coordinate of the P^{th} trajectory point is added to the trajectory. When the coordinate information of the M^{th} trajectory point is (xᵢ, yᵢ) and the coordinate of the M+1^{th} trajectory point is (xᵢ+1, yᵢ+1), the value of the P^{th} trajectory point in the X-axis coordinate is

$$x = \frac{{x}_{i + 1} + {x}_{i}}{2}$$

and the value of the P^{th} trajectory point in the Y-axis coordinate is

$$y = \frac{{y}_{i + 1} + {y}_{i}}{2} .$$

In some embodiments of the present disclosure, the iteratively correcting the N trajectory points in the first boundary at block 203 may executed by block 701 to block 702.

At block 701, the coordinate data of the interpolation point is obtained.

The coordinate data of the interpolation point is obtained as described at block 602, which will not be described herein.

At block 702, the interpolation point is supplemented to a position between the first trajectory point and the second trajectory point to complete the correction based on the coordinate data of the interpolation point.

In the embodiments of the present disclosure, when performing difference optimization, the X-axis coordinate values and the Y-axis coordinate values of the position information of the M^{th} trajectory point and the M+1^{th} trajectory point may be calculated to obtain the position information of the P trajectory point. The position information of the P trajectory point is supplemented to the first boundary, so that the trajectory points of the first boundary are more evenly distributed and the trajectory is smoother.

The trajectory diagram shown in FIG. 3a is an initial trajectory diagram without trajectory processing. It can be clearly seen that the first trajectory point and the second trajectory point do not coincide, causing the intelligent device to be unable to drive smoothly and normally. When the first trajectory point as the starting point and the second trajectory point as the ending point, the device may fail to return to the starting point normally, thereby affecting the automatic control of the device. The trajectory diagram shown in FIG. 3b is an initial trajectory diagram after trajectory processing. In the figure, due to the first trajectory point and the second trajectory point have coincided, so for the sake of clarity, the second trajectory point is not labeled. After correction processing, a closed trajectory line is achieved, and the trajectory formed by the trajectory points is smooth and conducive to the walking of the robot.

In the embodiments of the present disclosure, by further correction deviating the adjacent trajectory points, it is solved that during the map generation process, the trajectory may be elongated due to the correction process or positioning deviation, resulting in the discontinuity of trajectory points. By obtaining the coordinates of the M^{th} trajectory point and the M+1^{th} trajectory point, the interpolation processing is performed, and the sum of the two coordinates is averaged to generate the coordinate of a middle point of the M^{th} trajectory point and the M+1^{th} trajectory point in the simulated trajectory. The coordinate of the middle point is supplemented to the trajectory to complete the correction of the trajectory.

In some embodiments of the present disclosure, the calculating the target deviation-correction data of the current iteration at block 202 may executed by block 801 to block 803.

At block 801, a target ray is obtained.

The target ray is generated based on at least the starting point and a center of gravity of the preset trajectory.

Before obtaining the target ray, an angle indicated by the target deviation value may be determined and the target deviation value may be calculated. An angle formed by the first trajectory point, the second trajectory point, and at least one trajectory point in the first boundary is obtained, and whether the angle is greater than the preset angle is determined.

The center of gravity may be used as an emission direction of the angle ray. The center of gravity may be configured to indicate an average position of all trajectory points in the X direction and Y direction in the preset trajectory for the ray.

In some embodiments, a coordinate value of the center of gravity in the X direction may be calculated by a formula:

$${x}_{center} = \frac{{\sum }_{i = 0}^{n} {x}_{i}}{n} .$$

Where xi represents the coordinate value of a current coordinate point in the X direction, n represents the number of all trajectory points in the trajectory map. The coordinate value of the center of gravity in the X-axis direction is obtained by performing averaging processing on the coordinates of all trajectory points in the X direction.

In some embodiments, a coordinate value of the center of gravity in the Y direction may be calculated by a formula:

$${y}_{center} = \frac{{\sum }_{i = 0}^{n} {y}_{i}}{n} .$$

Where yi represents the coordinate value of the current coordinate point in the Y direction, n represents the number of all trajectory points in the trajectory map. The coordinate value of the center of gravity in the Y-axis direction is obtained by performing averaging processing on the coordinates of all trajectory points in the Y direction.

By calculating the center of gravity, it is convenient to consider the emission direction of the ray from the perspective of the overall trajectory. At the same time, the offset of the center of gravity value may be taken into account, thereby improving the effectiveness of generating valid points.

As shown in FIG. 4a, during the trajectory correction process, due to the long distance between the ending point and the starting point or other positioning reasons, an acute-angled intersection (i.e., an angle of the intersection between two boundary lines may less than 90 degrees) may be formed in the closed-loop map after trajectory correction. In this case, it is not conducive to the working of the robot.

When a target angle of the current trajectory point exceeds a preset angle threshold, the center of gravity is obtained and a ray is emitted according to the center of gravity. A point that the ray intersects with the first boundary is marked as a valid point. The trajectory points in the first boundary and the valid point are connected to update the first boundary.

When the target angle of the current trajectory point does not exceed the preset angle threshold, the current trajectory point is determined to be a normal trajectory point. There is no need to perform trajectory offset correction, the trajectory deviation-correction processing refer to the method mentioned above may be directly performed on a next trajectory point until the trajectory deviation-correction processing performed on each trajectory point in the trajectory data to be processed is completed.

In the embodiments of the present disclosure, the ray may refer to the starting point of the trajectory and position of the center of gravity when generating. The starting point, i.e., a starting point of the intelligent device is taken as an original point, and a ray r is emitted at an angle of a with the starting running direction towards the position of a mean point of the trajectory.

At block 802, coordinate data of a real-time intersection point is obtained in response to the target ray intersecting with the first boundary.

Based on the target coordinate system, the coordinate of the starting point of the trajectory is taken as a starting point, the target ray is emitted along the direction of the center of gravity. Whether the target ray intersects with the first boundary is detected. For example, a ray along the direction of the center of gravity and an angle of the ray with the X-axis of the target coordinate system is 120°. Whether the trajectory of the ray has an intersection with the first boundary is detected. If so, the intersection is recorded.

In order to improve the accuracy of correction and avoid excessive errors caused by the ray, for example, if the target ray intersects the first boundary in the preset trajectory, deleting a trajectory between the intersection point and the starting point may cause the trajectory route to change. Thus, the length of the ray may be set based on the driving distance of the trajectory and positioning errors. For example, a segment with a length of lr is intercepted on the ray r, and one of the endpoints of the segment is the origin point. When determining the intersection, it is only need to determine whether the ray segment within the length intersects the first boundary. The length lr is related to the positioning errors. For example, in a map with an area of 500 m², if the positioning error δ=1 m, the length lr is selected as 3δ.

In order to improve the accuracy of correction and avoid the acute angle forming by the starting point and the first boundary, the first ray may set to emission along the angle of the emission direction of the center of gravity, so that the angle of the trajectory points in the trajectory generated by the intersection point and the starting point may be an obtuse angle, which is convenient for the driving and operation of the device.

If the target ray does not intersect with the first boundary, there is no need to perform trajectory offset correction, the trajectory deviation-correction processing refer to the method mentioned above may be directly performed on a next trajectory point until the trajectory deviation-correction processing performed on each trajectory point in the trajectory data to be processed is completed.

If the target ray does not intersect with the first boundary, the coordinate of the intersection point is obtained, the trajectory point is performed by the deviation correction processing, and the trajectory map is updated.

The method of determining whether there is an intersection may be realized by a mutual exclusion experiment of line segments and a straddling experiment of line segments. If there is an intersection, the trajectory points after the intersection number are deleted, and the line segment from the origin point to the intersection is integrated into the total trajectory as a compensation trajectory. Thus, the angle threshold is defined to correct the situation of acute angles.

The mutual exclusion experiment of line segments may determine whether rectangles of two line segments intersect. If the rectangles intersect, whether the line segments intersect may continue to be determined. The straddling experiment of line segments determined a positional relationship between two vectors based on a cross product of the line segments.

At block 803, the target correction data is generated based on the position information of the intersection point.

The position information of the intersection point may include coordinate data (x, y) in the target coordinate system.

In the embodiments of the present disclosure, the ray generated by the starting point in the preset trajectory and the center of gravity is obtained, and whether the ray has the intersection with the trajectory boundary is determined, thereby correcting the trajectory points in the preset trajectory with an angle smaller than the threshold, avoiding the work errors of the device during the automatic driving process caused by the problem of the trajectory angle in the preset trajectory, and improving the accuracy of trajectory generation.

In some embodiments of the present disclosure, the iteratively correcting the N trajectory points in the first boundary at block 203 may executed by block 901 to block 902.

At block 901, the position information of the intersection point is obtained.

The method of obtaining the position information of the intersection point is as described at block 803, which will not be described herein.

Furthermore, coordinate data of at least one coordinate trajectory point between the intersection point and the starting point may be generated based on the coordinate data of the intersection point and the coordinate data of the starting point, thereby making the trajectory between the intersection point and the starting point smoother and improving the stability and controllability of device driving.

At block 902, the trajectory point in the first boundary is deleted based on the position information of the intersection point to complete the deviation correction.

When deleting the trajectory point in the first boundary, the intersection point of the center of gravity and the first boundary is determined, an offset point between the starting point and the intersection point is determined based on the intersection point, the offset point is deleted from the trajectory map, and the trajectory map is regenerated based on the intersection point and the starting point, avoiding the return problem caused by angle problems.

As shown in FIG. 5, the starting point is used as a starting point for emitting the ray, and a ray of a preset length (being set according to the positioning error) is emitted at a preset angle (e.g., 120°) along the trajectory coordinate direction of the center of gravity. If the ray has an intersection with the first boundary, the intersection is marked as a valid point and position information of the valid point is obtained. For example, in FIG. 5, if the intersection the ray intersecting with the first boundary is trajectory point D, the trajectory points with angles smaller than the preset angle between the trajectory point B and the original trajectory point are deleted, and the trajectory point B and the trajectory point D are connected to generate a new boundary.

The intersection points determined at block 803 are connected to adjacent trajectory points respectively. The target ray is deleted. A boundary line is regenerated based on the coordinate data of the intersection points and the coordinate data of the first trajectory point. The boundary line is updated to the first boundary to complete the correction processing of the trajectory points. The first boundary is corrected based on the coordinate position of the center of gravity so that the target angle is smaller than the preset angle.

A trajectory map as shown in FIG. 4a is an initial trajectory map without trajectory processing. It can be clearly seen that in the map generated after preliminary correction processing or positioning error, an acute angle is formed by a trajectory in a starting direction and a trajectory in a returning direction, and the acute angle is not conducive to the operation of power tools.

A trajectory map as shown in FIG. 4b is a target trajectory map after the trajectory processing. An included angle formed by the trajectory in the starting direction and the trajectory in the returning direction is corrected. The angle of the included angle is corrected to an obtuse angle, such that the angle formed by the starting direction and the returning direction at the starting position is an obtuse angle, which improves the working efficiency of the intelligent tools.

In the embodiments of the present disclosure, the acute angle at the starting point of the trajectory is corrected into an obtuse angle by an angle threshold limiting method, which may be more conducive to the efficient work of the device and also facilitate the smooth return of the device to the station.

The embodiments of the present disclosure provided the trajectory processing method, after obtaining the trajectory data, for the trajectory where the starting point and the ending point are not closed, the correction processing of trajectory points may be completed by moving the trajectory near the ending point. For a large gap between a front trajectory point and a rear trajectory point of two adjacent trajectory points, the coordinate points may be supplemented between the front and rear trajectory points to avoid trajectory discontinuity. For the acute-angled boundaries in the trajectory, the intersection points in the boundary may be screened through the center of gravity of the trajectory, and the offset point may be deleted. At a position corresponding to the offset point in the initial corrected trajectory, the first boundary is updated to form a complete trajectory. Through the multiple trajectory correction processing strategies mentioned above, different errors in the trajectory may be solved, and the efficiency and accuracy of trajectory generation are improved.

It should be understood that although various steps in the flow chart are shown in sequence as indicated by arrows, these steps are not necessarily executed in the order indicated by the arrows. Unless clearly stated herein, there is no strict order restriction on the execution of these steps, and these steps may be executed in other orders. Moreover, at least some of the steps in the flow chart may include multiple sub-steps or multiple stages. These sub-steps or stages are not necessarily executed at the same time, but may be executed at different times. The execution order of these sub-steps or stages is not necessarily in sequence either, but may be executed alternately or in turn with at least a part of other steps or sub-steps or stages of other steps.

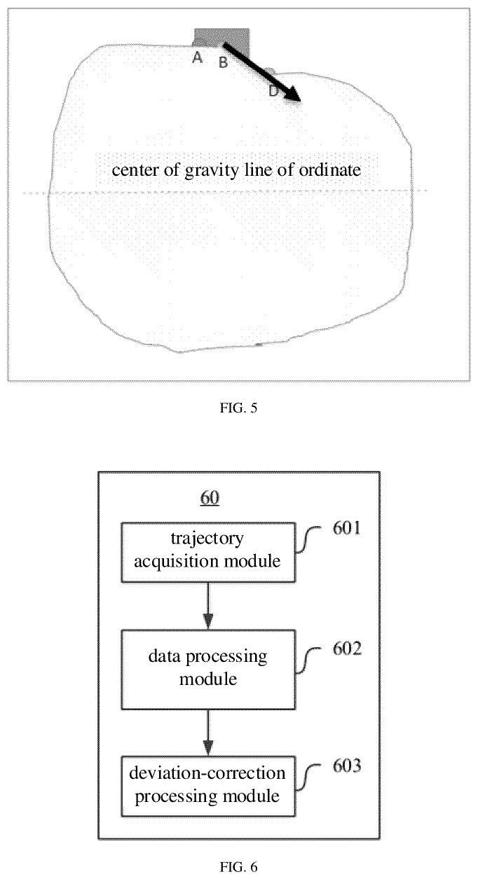

As shown in FIG. 6, the embodiments of the present disclosure provide a trajectory processing apparatus 60. The trajectory processing apparatus 60 includes a trajectory acquisition module 601, a data processing module 602, and a deviation-correction processing module 603.

The trajectory acquisition module 601 is configured to obtain target deviation data. The target deviation data is configured to indicate deviation between a first trajectory point and a second trajectory point.

The data processing module 602 is configured to calculate target deviation-correction data of a current iteration based on the target deviation data.

The deviation-correction processing module 603 is configured to iteratively correct at least one of N trajectory points in a first boundary based on the target deviation-correction data, enabling target deviation data to meet a preset threshold. The first boundary is a boundary composed of the second trajectory point in an initial trajectory and multiple trajectory points within a preset range of the second trajectory point.

The trajectory processing apparatus provided by the embodiment of the present disclosure obtains multiple trajectory points. When the target deviation data between the multiple trajectory points does not meet the preset requirement, the deviation correction processing is performed. The deviation correction data is obtained and the deviation correction processing is performed on the trajectory points based on the deviation correction data, so as to achieve the technical effect of accurately generating a map based on the trajectory points and improve the efficiency and accuracy of trajectory generation.

In some embodiments of the present disclosure, a device is provided with at least the trajectory processing apparatus 60. The device corrects the trajectory driven by the intelligent device to the initial position by using the proportional correction method, and improves the map established by the intelligent device after driving along the route through methods such as scattered point completion and angle threshold correction to form a closed-loop in the form of an obtuse angle. In this way, the problem of low working efficiency caused by non-closed maps or unsmooth maps with large fluctuations and changes is effectively solved, improving the working efficiency of the lawn mower to cut along a line.

For specific limitations on the above equipment, reference may be made to the limitations on the trajectory processing method mentioned above, and will not be described herein. Each module in the device may be implemented entirely or partially by software, hardware, and combinations thereof. Each module may be embedded in a processor of a computer device in hardware form or independently of the processor, or may be stored in a storage of the computer device in software form, so that the processor may call and execute operations corresponding to each module.

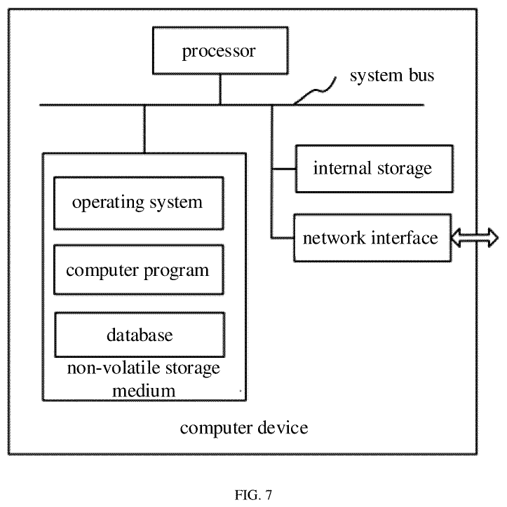

In some embodiments of the present disclosure, a computer device is provided. The internal structure of the computer device may be shown in FIG. 7. The computer device includes a processor, a storage, a network interface, and a database, which are connected through a system bus. The processor of the computer device is configured to provide computing and control capabilities. The storage of the computer device includes a non-volatile storage medium and an internal storage. The non-volatile storage medium stores an operating system, a computer program, and a database. The internal storage provides an environment for the operation of the operating system and computer programs in the non-volatile storage medium. The database of the computer device is configured to store data. The network interface of the computer device is configured to communicate with and connected with an external terminal through a network. When the computer program is executed by the processor, the trajectory processing method as described above is implemented. The computer device includes the storage and the processor. The storage stores the computer program. When the processor executes the computer program, any one of the blocks in the trajectory processing method is implemented.

In some embodiments of the present disclosure, a computer-readable storage medium is provided, on which a computer program is stored. When the computer program is executed by a processor, any one of the blocks in the trajectory processing method may be implemented.

Those skilled in the art may understand that the embodiments of the present disclosure may be provided as methods, systems, or computer program products. The present disclosure may take the form of a completely hardware embodiment, a completely software embodiment, or an embodiment combining software and hardware. Furthermore, the present disclosure may take the form of a computer program product implemented on one or more computer-usable storage medium (including, but not limited to, disk storage, computer disc read-only storage (CD-ROM), optical storage, etc.) including computer-usable program code.

The present disclosure is described with reference to flowcharts and/or block diagrams of methods, apparatuses, systems, and computer program products according to the embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing device to produce a machine, such that the instructions executed by the processor of the computer or other programmable data processing device generate means for implementing the functions specified in one process or multiple processes in the flowchart and/or one block or multiple blocks of the block diagram.

Although the embodiments of the present disclosure have been described, once those skilled in the art learn of basic creative concepts, they may be able to make other changes and modifications to the embodiments. Therefore, the appended claims are intended to be construed as including the embodiments and all changes and modifications that fall within the scope of the present disclosure.

Obviously, those skilled in the art may make various changes and modifications to the present disclosure without departing from the principles and scope of the present disclosure. In this way, if these modifications and variations of the present disclosure fall within the scope of the claims of the present disclosure and its equivalent technology, then the present disclosure is also intended to include these modifications and variations.

1-10. (canceled)

11. A trajectory processing method, applied to a processor and comprising:
obtaining target deviation data configured to indicate deviation between a first trajectory point and a second trajectory point;
calculating target deviation-correction data of a current iteration based on the target deviation data; and
iteratively correcting at least one of N trajectory points in a first boundary based on the target deviation-correction data, enabling target deviation data to meet a preset threshold, wherein the first boundary is a boundary composed of the second trajectory point in an initial trajectory and a plurality of trajectory points within a preset range of the second trajectory point.

12. The trajectory processing method according to claim 11, wherein iteratively correcting the N trajectory points in the first boundary comprises:
calculating displacement data of each of the N trajectory points in the first boundary corrected by the current iteration based on the target deviation-correction data of the current iteration;
calculating deviation values of the first trajectory point and the second trajectory point based on the displacement data and updating the target deviation data;
in response to the target deviation data being greater than or equal to the preset threshold, calculating target deviation-correction data of a current iteration based on the target deviation data, and iteratively correcting the N trajectory points in the first boundary based on the target deviation-correction data; and
in response to the target deviation data being less than the preset threshold, stopping an iterative correction process.

13. The trajectory processing method according to claim 11, wherein the calculating target deviation-correction data of a current iteration comprises:
obtaining deviation values of the first trajectory point and the second trajectory point in at least one coordinate axis in sequence based on a target coordinate system; and
calculating target deviation-correction data of a trajectory point of the current iteration in at least one coordinate axis based on target deviation data of the first trajectory point and the second trajectory point in each coordinate axis.

14. The trajectory processing method according to claim 13, wherein iteratively correcting the N trajectory points in the first boundary comprises:
correcting a coordinate value of a trajectory point of the current iteration in at least one coordinate axis of the target coordinate system in sequence based on target deviation-correction data of the trajectory point in at least one coordinate axis of the target coordinate system.

15. The trajectory processing method according to claim 14, wherein the correcting a coordinate value of a trajectory point of the current iteration in at least one coordinate axis of the target coordinate system comprises:
obtaining position information and target distance weight of a Mth trajectory point among the N trajectory points in sequence based on the target coordinate system, wherein the target distance weight comprises a first distance weight in an X direction and a second distance weight in a Y direction;
correcting a distance of the M^{th} trajectory point in the X direction based on the first distance weight and correcting a distance of the M^{th} trajectory point in the Y direction based on the second distance weight; and
completing correction of all the trajectory points among the N trajectory points to complete a correction of the first boundary.

16. The trajectory processing method according to claim 11, wherein the calculating target deviation-correction data of a current iteration comprises:
obtaining coordinate information of the first trajectory point and coordinate information of the second trajectory point respectively based on a target coordinate system; and
determining coordinate data of an interpolation point of the first trajectory point and the second trajectory point in the target coordinate system based on the coordinate information of the first trajectory point and the coordinate information of the second trajectory point, and generating the target deviation-correction data.

17. The trajectory processing method according to claim 16, wherein iteratively correcting the N trajectory points in the first boundary comprises:
supplementing the interpolation point to a position between the first trajectory point and the second trajectory point to complete a correction based on the coordinate data of the interpolation point.

18. The trajectory processing method according to claim 11, further comprising:
obtaining a target ray generated based on at least a starting point and a center of gravity of a preset trajectory;
obtaining coordinate data of a intersection point of the target ray and the first boundary in response to the target ray intersecting with the first boundary; and
generating the target deviation-correction data based on the coordinate data of the intersection point.

19. The trajectory processing method according to claim 18, wherein iteratively correcting the N trajectory points in the first boundary comprises:
replacing a trajectory point in the first boundary based on the coordinate data of the intersection point to iteratively correct the N trajectory points in the first boundary.

20. The trajectory processing method according to claim 11, wherein the obtaining target deviation data comprises:
obtaining position information of the first trajectory point and position information of the second trajectory point of the first boundary;
obtaining target deviation data between the second trajectory point and the first trajectory point based on the position information of the first trajectory point and the position information of the second trajectory point of the first boundary.

21. The trajectory processing method according to claim 20, wherein the target deviation data is configured to indicate distance deviation between the second trajectory point and the first trajectory point, the obtaining target deviation data between the second trajectory point and the first trajectory point based on the position information of the first trajectory point and the position information of the second trajectory point of the first boundary comprises:
calculating a first distance between the second trajectory point and the first trajectory point in a direction of X-axis of a target coordinate system; and
calculating a second distance between the second trajectory point and the first trajectory point in a direction of Y-axis of the target coordinate system.

22. A device, comprising a storage and a processor, wherein the storage is configured to store a computer program, the computer program is executed by the processor to implement a trajectory processing method, and the method comprises:
obtaining target deviation data configured to indicate deviation between a first trajectory point and a second trajectory point;
calculating target deviation-correction data of a current iteration based on the target deviation data; and
iteratively correcting at least one of N trajectory points in a first boundary based on the target deviation-correction data, enabling target deviation data to meet a preset threshold, wherein the first boundary is a boundary composed of the second trajectory point in an initial trajectory and a plurality of trajectory points within a preset range of the second trajectory point.

23. The device according to claim 22, wherein iteratively correcting the N trajectory points in the first boundary comprises:
calculating displacement data of each of the N trajectory points in the first boundary corrected by the current iteration based on the target deviation-correction data of the current iteration;
calculating deviation values of the first trajectory point and the second trajectory point based on the displacement data and updating the target deviation data;
in response to the target deviation data being greater than or equal to the preset threshold, calculating target deviation-correction data of a current iteration based on the target deviation data, and iteratively correcting the N trajectory points in the first boundary based on the target deviation-correction data; and
in response to the target deviation data being less than the preset threshold, stopping an iterative correction process.

24. The device according to claim 22, wherein the calculating target deviation-correction data of a current iteration comprises:
obtaining deviation values of the first trajectory point and the second trajectory point in at least one coordinate axis in sequence based on a target coordinate system; and
calculating target deviation-correction data of a trajectory point of the current iteration in at least one coordinate axis based on target deviation data of the first trajectory point and the second trajectory point in each coordinate axis.

25. The device according to claim 24, wherein iteratively correcting the N trajectory points in the first boundary comprises:
correcting a coordinate value of a trajectory point of the current iteration in at least one coordinate axis of the target coordinate system in sequence based on target deviation-correction data of the trajectory point in at least one coordinate axis of the target coordinate system.

26. The device according to claim 22, wherein the calculating target deviation-correction data of a current iteration comprises:
obtaining coordinate information of the first trajectory point and coordinate information of the second trajectory point respectively based on a target coordinate system; and
determining coordinate data of an interpolation point of the first trajectory point and the second trajectory point in the target coordinate system based on the coordinate information of the first trajectory point and the coordinate information of the second trajectory point, and generating the target deviation-correction data.

27. The device according to claim 26, wherein iteratively correcting the N trajectory points in the first boundary comprises:
supplementing the interpolation point to a position between the first trajectory point and the second trajectory point to complete a correction based on the coordinate data of the interpolation point.

28. The device according to claim 22, wherein the method further comprises:
obtaining a target ray generated based on at least a starting point and a center of gravity of a preset trajectory;
obtaining coordinate data of a intersection point of the target ray and the first boundary in response to the target ray intersecting with the first boundary; and
generating the target deviation-correction data based on the coordinate data of the intersection point.

29. The device according to claim 28, wherein iteratively correcting the N trajectory points in the first boundary comprises:
replacing a trajectory point in the first boundary based on the coordinate data of the intersection point to iteratively correct the N trajectory points in the first boundary.

30. A computer-readable storage medium, configured to store a computer program, wherein the computer program is performed by a processor to implement a trajectory processing method, and the method comprises:
obtaining target deviation data configured to indicate deviation between a first trajectory point and a second trajectory point;
calculating target deviation-correction data of a current iteration based on the target deviation data; and
iteratively correcting at least one of N trajectory points in a first boundary based on the target deviation-correction data, enabling target deviation data to meet a preset threshold, wherein the first boundary is a boundary composed of the second trajectory point in an initial trajectory and a plurality of trajectory points within a preset range of the second trajectory point.
